(19) United States
(12) Patent Application Publication
(10) Pub. No.: US 2024/0256858 A1
(43) Pub. Date: Aug. 1, 2024

(54) Outcome-Guided Counterfactuals from a Jointly Trained Generative Latent Space

(71) Applicant: SRI International, Menlo Park, CA (US)

(72) Inventors: Chih-hung YEH, Alameda, CA (US); Pedro Daniel BARBOSA SEQUEIRA, Palo Alto, CA (US); Melinda T. GERVASIO, Mountain View, CA (US); Jesse Albert HOSTETLER, Boulder, CO (US)

(21) Appl. No.: 18/393,182

(22) Filed: Dec. 21, 2023

Related U.S. Application Data
(60) Provisional application No. 63/439,815, filed on Jan. 18, 2023.

(51) Int. Cl. G06N 3/08; G06N 3/0475

(52) U.S. Cl. CPC G06N 3/08; G06N 3/0475

(57) ABSTRACT

In general, techniques are described for generating counterfactuals using a machine learning system that implements a generative model. In an example, a method includes receiving, by a trained generative machine learning model, an input query, wherein the generative machine learning model is trained by jointly encoding a plurality of input observations and a plurality of outcome variables based on the plurality of input observations; generating, by the trained generative machine learning model, latent representation of the input query; and transforming, by the trained generative machine learning system, the latent representation of the input query to generate a counterfactual related to the received input query, wherein the generated counterfactual meets a predefined outcome criteria.

This application claims the benefit of U.S. patent Application No. 63/439,815, filed Jan. 18, 2023, which is incorporated by reference herein in its entirety.

### GOVERNMENT RIGHTS

This invention was made with Government support under contract number HR001119C0112 awarded by the Defense Advanced Research Projects Agency (DARPA). The Government has certain rights in this invention.

### TECHNICAL FIELD

This disclosure is related to machine learning systems, and more specifically to the generation of outcome-guided counterfactuals from a jointly trained generative latent space.

### BACKGROUND

Counterfactual generation is the process of creating hypothetical scenarios that differ from an observed event in a specific way. The hypothetical scenarios are often used to understand the causal relationships between different factors and to explore what could have been. The traditional approach to counterfactual generation involves pulling examples from a repository of observed instances. The traditional approach may be effective if the repository contains a large number of examples that are similar to the query. However, it may be difficult to find a counterfactual that is similar enough to the query, especially if the query is for a rare or unusual event. An alternative approach to counterfactual generation is to use incremental changes to scenes to generate a new counterfactual. The incremental changes approach may be effective for generating counterfactuals for events that are not well-represented in the repository of observed instances.

However, both of the aforementioned approaches may produce unrealistic or anomalous counterfactuals, which may be misleading.

### SUMMARY

In general, techniques are described for generating counterfactuals using a machine learning system that implements a generative model. A generative model is a type of machine learning model that learns the underlying patterns or distributions of data in order to generate new, similar data. In the context of counterfactual generation, the generative model may be trained on a dataset of observed examples and their associated outcomes. Such training may allow the generative model to learn the relationships between different factors and to generate new examples that are similar to the observed examples but that have a different outcome. The disclosed system may implement a jointly trained model in which the generative model has been trained to generate both unobserved examples and their associated outcomes. Such training allows the generative model to generate counterfactuals that are not only similar to the query, but they also have the desired outcome.

In some examples, the disclosed system allows the user to guide the counterfactual generation process by specifying one or more constraints. The specified constraints allow the user to control the factors that are changed in the counterfactual and to ensure that the counterfactual is relevant to their query.

In some examples, the disclosed system samples examples that are close enough to the original query to be relevant. Sampling may ensure that the counterfactuals are believable and that the counterfactuals provide meaningful insights into the query. The disclosed system may use a plausibility adjustment to modify the counterfactual to make each counterfactual more plausible or less anomalous. Plausibility adjustment may help to ensure that the counterfactuals are realistic, and that they do not violate the laws of physics.

The techniques may provide one or more technical advantages that realize at least one practical application. For example, the traditional approach to counterfactual generation using generative models only utilizes observations from the environment, limiting the model's ability to generate counterfactuals that align with desired outcomes. In contrast, the disclosed techniques provide a training regime that addresses the aforementioned limitation by jointly encoding both a Reinforcement Learning (RL) agent's observations and the outcome variables into the generative model's latent space. Such joint encoding may allow the generative model to capture the relationships between observations and outcomes, enabling it to generate counterfactuals that not only resemble the observed scenarios but also lead to the desired outcomes. For example, one of the challenges in generating counterfactuals is ensuring that the generated scenarios are realistic and plausible. To address this challenge, the disclosed techniques may leverage the generative model's ability to reconstruct observations and predict outcomes. By analyzing the discrepancies between the generated counterfactuals and their reconstructions, the model may identify anomalies in the generated counterfactuals. These anomalies may then be adjusted to make the counterfactuals more plausible, increasing their believability and usefulness. These dual techniques of joint observation and outcome encoding and of anomaly-driven plausibility adjustment may enhance the quality of generated counterfactuals, making them more relevant, plausible, and insightful for decision-making and causal analysis. The ability to tailor counterfactuals to specific outcomes and explore multiple criteria simultaneously is another advantage that allows for more targeted and nuanced analysis, potentially leading to deeper insights and more robust explanations. The possibility of exploring counterfactuals where only one outcome is altered while keeping others constant provides a powerful tool for understanding causal relationships and the impact of specific interventions.

In an example, a method includes, receiving, by a trained generative machine learning model, an input query, wherein the generative machine learning model is trained by jointly encoding a plurality of input observations and a plurality of outcome variables based on the plurality of input observations; generating, by the trained generative machine learning model, latent representation of the input query; and transforming, by the trained generative machine learning system, the latent representation of the input query to generate a counterfactual related to the received input query, wherein the generated counterfactual meets a predefined outcome criteria.

In an example, a system includes processing circuitry in communication with storage media, the processing circuitry configured to execute a machine learning system configured to: receive, by a trained generative machine learning model, an input query, wherein the generative machine learning model is trained by jointly encoding a plurality of input observations and a plurality of outcome variables based on the plurality of input observations; generate, by the trained generative machine learning model, a latent representation of the input query; and transform, by the trained generative machine learning model, the latent representation of the input query to generate a counterfactual related to the received input query, wherein the generated counterfactual meets a predefined outcome criteria.

In an example, non-transitory computer-readable storage media having instructions encoded thereon, the instructions configured to cause processing circuitry to: receive, by a trained generative machine learning model, an input query, wherein the generative machine learning model is trained by jointly encoding a plurality of input observations and a plurality of outcome variables based on the plurality of input observations; generate, by the trained generative machine learning model, a latent representation of the input query; and transform, by the trained generative machine learning model, the latent representation of the input query to generate a counterfactual related to the received input query, wherein the generated counterfactual meets a predefined outcome criteria.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a high-level component diagram of an illustrative system architecture in accordance with the techniques of the disclosure.

FIG. 2 is a detailed block diagram illustrating an example system in accordance with the techniques of the disclosure.

FIG. 3 is a conceptual diagram illustrating an example of a counterfactual generation architecture according to techniques of this disclosure.

FIG. 4 is a graph illustrating an example Evidence Lower Bound (ELBO) loss against number of the round trips for the input according to techniques of this disclosure.

FIG. 5 is a conceptual diagram illustrating example environments that could be used in counterfactual generation according to techniques of this disclosure.

FIG. 6 is a flowchart illustrating an example mode of operation for a generative machine learning system, according to techniques described in this disclosure.

Like reference characters refer to like elements throughout the figures and description.

### DETAILED DESCRIPTION

Self-driving vehicles are examples of autonomous systems trained using RL, a machine learning technique. Self-driving vehicles are complex systems that make decisions based on a variety of factors, including, but not limited to, sensor data, maps, and algorithms. These decisions may have life-or-death consequences, and so it is important for humans to understand how self-driving vehicles make decisions. One way to help humans understand self-driving vehicle behavior is to use counterfactuals. Counterfactuals are hypothetical scenarios that differ from an observed event in a specific way.

Counterfactuals may be used to show how the system would have behaved or would behave if one or more factors had been different. In the context of self-driving vehicles, counterfactuals may be used to show how the vehicle would have responded if a different object had been present in the scene, or if the vehicle had been traveling at a different speed. Counterfactuals may help humans to understand the factors that the vehicle is considering when making decisions. For example, consider a scenario where a self-driving vehicle is approaching a crosswalk. The vehicle's sensors may detect a pedestrian in the crosswalk, and the vehicle may slow down to let the pedestrian cross. A human user may want to understand how the vehicle would have behaved if the pedestrian had not been there. A counterfactual may be generated by removing the pedestrian from the scene and simulating how the vehicle would have responded. In this case, the vehicle would have continued driving at its original speed. The aforementioned counterfactual may help the human user to understand that the vehicle is able to detect and respond to pedestrians in the crosswalk. In another example, a vehicle approaches a crosswalk and recognizes there is an empty crosswalk, but the vehicle's sensors may detect a child or an animal on a side of the road and recognizes that there is the potential for a catastrophic outcome. Behavior of the self-driving vehicle may change dramatically given a minor change in the current scene or observations.

Counterfactuals are a valuable tool for explaining self-driving vehicle behavior and/or any other RL agent behavior because they are easy to understand, actionable and persuasive. Humans are naturally good at understanding counterfactuals because they are similar to the way we think about the world. Counterfactuals may help humans to understand how self-driving vehicles make decisions, which may help humans to trust the vehicles and feel more comfortable riding in them. Counterfactuals may be used to show humans that self-driving vehicles are safe and reliable, which may help to overcome concerns about the technology.

RL has emerged as a powerful technique for training agents to make optimal decisions in complex environments. However, understanding the behavior of RL agents, especially those trained using deep neural networks, may be challenging due to the inherent complexity of these models. Counterfactual explanations, which describe hypothetical scenarios that would have led to a different outcome, may provide valuable insights into the decision-making process of RL agents.

To address the limitations of traditional counterfactual generation methods, which often rely on hand-crafted rules or domain-specific knowledge, the disclosed system implements a novel generative model, which in one implementation may be based on a variational autoencoder (VAE). The VAE may be trained on a corpus of input observations, such as RL agent trajectories, and corresponding outcome variables, enabling the VAE to learn the underlying patterns and relationships between observations and outcomes.

A key aspect of the disclosed model is the model's ability to jointly reconstruct the agent's observations and predict outcome variables. This joint latent representation may capture the correlations between observations and outcomes, allowing the model to generate counterfactuals that not only resemble the observed scenarios but also lead to different outcomes. The joint latent representation may enable unconditioned sampling.

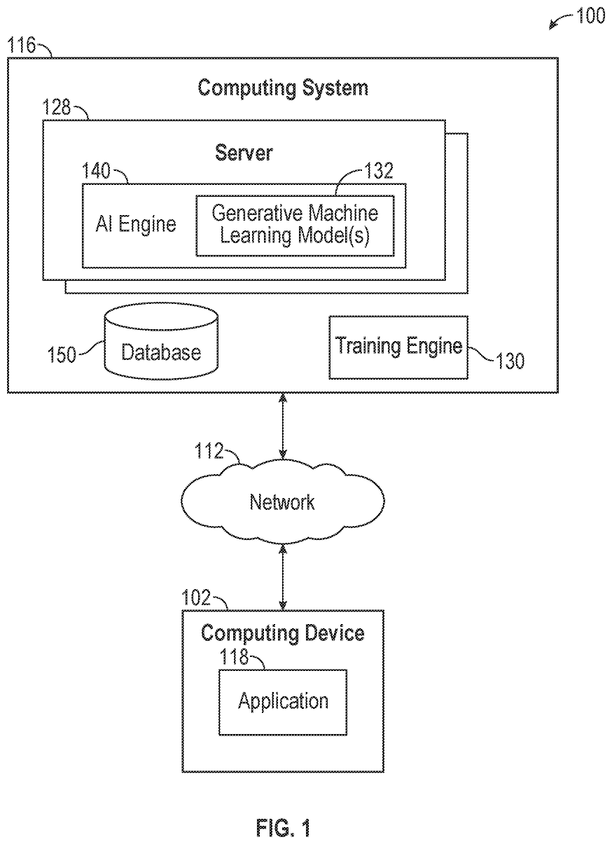

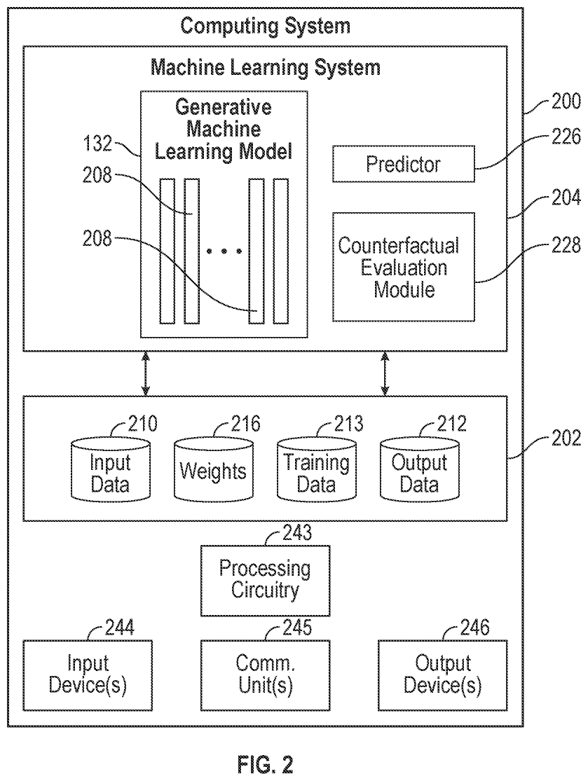

FIG. 1 is a high-level component diagram of an illustrative system architecture 100 in accordance with the techniques of the disclosure. In some aspects, the system architecture 100 may include a computing device 102 communicatively coupled to a computing system 116. Each of the computing device 102 and components included in the computing system 116 may include one or more processing devices, memory devices, and/or network interface cards, as described below in conjunction with FIG. 2. Computing device 102 and the computing system 116 may communicate with a network 112. Network 112 may be a public network (e.g., connected to the Internet via wired (Ethernet) or wireless (Wi-Fi)), a private network (e.g., a local area network (LAN) or wide area network (WAN)), or a combination thereof. Network 112 may also comprise a node or nodes on the Internet of Things (IoT).

The computing device 102 may be any suitable computing device, such as, but not limited to, a laptop, tablet, smartphone, or computer. The computing device 102 may include a display capable of presenting a user interface of an application 118. The application 118 may be implemented in computer instructions stored on the one or more memory devices of the computing device 102 and executable by the one or more processing devices of the computing device 102. The application 118 may present various screens to a user that present various views including but not limited to counterfactual evaluation measures, predictions of outcome variables, and/or other information pertaining to the generated counterfactuals.

In some aspects, the computing system 116 may include one or more servers 128 that form a distributed computing architecture. The servers 128 may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers 128 may include one or more processing devices, memory devices, data storage, and/or network interface cards. The servers 128 may be in communication with one another via any suitable communication protocol. The servers 128 may execute an artificial intelligence (AI) engine 140. AI engine 140 may include one or more machine learning systems (such as machine learning system 204 shown in FIG. 2), at least one of which may use one or more generative machine learning models 132 to perform at least one of the techniques disclosed herein. The computing system 116 may also include a database 150 that may store data, knowledge, and data structures used to perform various techniques. For example, the database 150 may store various counterfactual criteria described further below. Further, the database 150 may store generated counterfactuals, corresponding counterfactual evaluation measures, plausibility adjustments, and the like. Although depicted separately from the server 128, in some implementations, the database 150 may be hosted on one or more of the servers 128.

In some aspects the computing system 116 may include a training engine 130 capable of generating one or more generative machine learning models 132. The generative machine learning models 132 may be trained to generate, create, classify, and/or test candidate counterfactuals, among other things. The one or more generative machine learning models 132 may be generated by the training engine 130 and may be implemented in computer instructions executable by one or more processing devices of the training engine 130 and/or the servers 128. To generate the one or more generative machine learning models 132, the training engine 130 may train the one or more generative machine learning models 132. The one or more generative machine learning models 132 may be used by any of the modules in the computing system architecture 200 depicted in FIG. 2.

The training engine 130 may be a rackmount server, a router computer, a personal computer, a portable digital assistant, a smartphone, a laptop computer, a tablet computer, a netbook, a desktop computer, an Internet of Things (IoT) device, any other desired computing device, or any combination of the above. The training engine 130 may be cloud-based, be a real-time software platform, include privacy software or protocols, and/or include security software or protocols.

To generate the one or more generative machine learning models 132, the training engine 130 may train the one or more generative machine learning models 132. The training engine 130 may use a base data set of counterfactuals for a particular domain.

The one or more generative machine learning models 132 may refer to model artifacts created by the training engine 130 using training data that includes training inputs and corresponding target outputs. The training engine 130 may find patterns in the training data, where such patterns map the training input to the target output and generate the generative machine learning models 132 that capture these patterns. Although depicted separately from the server 128, in some implementations, the training engine 130 may reside on server 128. Further, in some implementations, the artificial intelligence engine 140, the database 150, and/or the training engine 130 may reside on the computing device 102.

As described in more detail below, the one or more generative machine learning models 132 may comprise a deep network, i.e., a machine learning model comprising multiple levels of non-linear operations. Examples of deep networks are neural networks, including generative neural networks. For example, the generative machine learning model 132 may include numerous layers and/or hidden layers that perform calculations (e.g., dot products) using various neurons. In some implementation, one or more of the generative machine learning models 132 may comprise a VAE trained to generate counterfactuals.

For example, the generative machine learning model 132 trained to help perform causal inference may accept one or more inputs, such as, but not limited to queries, criteria for successful counterfactuals, and the like. The generative machine learning model 132 may be trained to output one or more outputs, such as, but not limited to (i) one or more generated counterfactuals, and (ii) one or more counterfactual evaluation measures (i.e., proximity, plausibility and validity). The queries may refer to scientific questions for which the answers are desired.

A VAE may be used to generate a set of candidate counterfactuals. A VAE refers to a type of generative model in machine learning that learns to represent data in a low-dimensional latent space. This allows the VAE to generate new data points that resemble the training data. In one implementation, the VAE may generate counterfactuals to calculate numerous alternative scenarios that indicate whether a certain result (e.g., activity level) still follows when any element or aspect of a sequence changes.

In an aspect, generative machine learning model 132 may be trained on a special dataset which may include, but is not limited to, observations and outcome variables. Observations may comprise a plurality of RL agent's observations. RL agent's observations may include, but are not limited to, the agent's perceptions and data points from various situations it encountered. A plurality of outcome variables may correspond to the aforementioned observations. These outcome variables may represent the different possible consequences or outcomes that could arise from the agent's actions in each situation. In an aspect, generative machine learning model 132 may jointly encode both the observations and the outcome variables. In other words, generative machine learning model 132 may combine the information from both sources into a single, compressed representation called a latent representation. This latent representation may capture the essence of the data and the relationships between observations and outcomes. In an aspect, the generative machine learning model 132 may receive an input query, which likely represents a specific scenario or situation. The model may use its knowledge of the latent representation to generate a counterfactual related to the query. This counterfactual is a simulated scenario that differs from the original query in some way. Importantly, the generated counterfactual may be designed to meet a predefined outcome criteria. In other words, generative machine learning model 132 may manipulate the latent representation to ensure the counterfactual scenario satisfies specific desired outcomes.

FIG. 2 is a block diagram illustrating an example computing system 200. In an aspect, computing system 200 may comprise an instance of a computing system 116 shown in FIG. 1. As shown, computing system 200 comprises processing circuitry 243 and memory 202 for executing a machine learning system 204 having a generative machine learning model 132 comprising a set of layers 208. Generative machine learning model 132 may be any of various types of generative machine learning models that can take an input observation and encode the observation into a lower-dimensional form for reconstruction, such as, but not limited to, autoencoder, VAE and Generative Adversarial Network (GAN).

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. Computing system 200 may represent an instance of the computing system 116 of FIG. 1.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media.

Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., predictor 226, counterfactual evaluation module 228), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, machine learning system 204 may receive input data from an input data set 210 and may generate output data 212. Input data 210 and output data 212 may contain various types of information. For example, input data 210 may include a plurality of query inputs and the like. Output data 212 may include information such as, but not limited to (i) one or more generated counterfactuals, and (ii) one or more counterfactual evaluation measures (i.e., proximity, plausibility and validity).

Each of layers 208 may include a corresponding set of artificial neurons. Layers 208 may include an input layer, a feature layer, an output layer, and one or more hidden layers, for example. Layers 208 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer. Various activation functions are known in the art, such as Rectified Linear Unit (ReLU), TanH, Sigmoid, and so on.

Machine learning system 204 may process training data 213 to train the generative machine learning model 132, in accordance with techniques described herein. For example, machine learning system 204 may apply an end-to-end training method that includes processing training data 213. Training data 213 may include, but is not limited to, observations and outcome variables. Observations may comprise a plurality of RL agent's observations. RL agent's observations may include, but are not limited to, the agent's perceptions and data points from various situations it encountered. A plurality of outcome variables may correspond to the aforementioned observations. These outcome variables may represent the different possible consequences or outcomes that could arise from the agent's actions in each situation. Machine learning system 204 may process input data 210 to generate relevant counterfactual examples that may be included in the training data 213 as described below.

As noted above, generative machine learning model 132 may employ a joint latent representation. The joint latent representation may enable unconditioned sampling. In other words, generative machine learning model 132 may generate new trajectories/counterfactuals without the need for explicit guidance or constraints. Such flexibility may allow for the integration of different counterfactual generation methods. One technique that may be employed by generative machine learning model 132 may be to use interpolations in latent space towards a case-based example, gradually modifying the latent representation to approach the desired outcome.

To further enhance the quality of generated counterfactuals, generative machine learning model 132 may incorporate gradient-driven updates. The disclosed techniques may be applied to RL agent's observations without requiring access to their internal mechanisms, enabling black-box analyses. Generative machine learning model 132 may learn from data, capturing the relationships between observations and outcomes directly from the training data 213.

The joint latent representation may provide insights into the factors that contribute to different outcomes. One of the key challenges in generating counterfactuals is ensuring that they are plausible. Plausible counterfactuals are especially important for black-box analyses of RL agents, where the internal workings of the agent are not readily available. Implausible counterfactuals may be misleading and ultimately reduce the credibility of the analysis.

Traditional counterfactual generation methods often struggle with plausibility. Case-based approaches that rely on existing instances may be limited in scope and may not be able to capture the full range of possible scenarios. Interpolations or synthesis techniques, while offering more flexibility, may sometimes lead to unrealistic and anomalous results.

By applying gradient-driven updates to the joint latent representation, generative machine learning model 132 may iteratively refine the generated counterfactuals to increase their data-likelihood. In other words, the counterfactuals may become more consistent with the observed data, making them more plausible and realistic. Gradient adjustments may significantly reduce the number of concrete anomalies in generated counterfactuals, leading to more realistic and believable scenarios.

Training a latent space that jointly encodes observations and outcomes enables generative machine learning model 132 to capture the dependencies between the two, which may be crucial for generating meaningful and relevant counterfactuals. By leveraging the joint latent space, the generated counterfactuals are more likely to be plausible and consistent with the observed data. Such plausibility and consistency may lead to more reliable and credible explanations for the agent's behavior. The disclosed framework may allow for flexible traversal over the latent space, enabling exploration of various counterfactual scenarios. Different types of constraints may be applied to guide the search, ensuring that the generated counterfactuals are relevant and meaningful for the specific analysis. As a result, high-quality counterfactuals may provide deeper insights into how the agent makes decisions based on observations.

Better understanding of agent behavior may be valuable for debugging, improving performance, and building trust in the agent. The joint latent space may facilitate the construction of interpretable counterfactuals, which may be readily understood by users and stakeholders. Such transparency may be crucial for building trust in complex AI systems. The framework may be flexible enough to be applied to a wide range of applications beyond RL, including, but not limited to, machine learning models, natural language processing, and even social science research.

By approximating the data-likelihood gradient, generative machine learning model 132 may guide the generation process towards more plausible and realistic scenarios. Such approximations may result in a significant reduction in the number of anomalous counterfactuals, ultimately enhancing the effectiveness and credibility of the explanations.

Instead of relying solely on random sampling or interpolations in the latent space, generative machine learning model 132 may incorporate gradient-based updates. The gradient-based updates aim to increase the data-likelihood of the generated counterfactual, ensuring the generated counterfactual aligns with the observed data and is more likely to occur in reality.

Calculating the exact data-likelihood gradient may be computationally expensive. Generative machine learning model 132 may use an efficient approximation, enabling its application to large and complex datasets. In an aspect, by pushing the counterfactuals towards higher data-likelihood, generative machine learning model 132 may effectively reduce the number of unrealistic and anomalous scenarios. Reduced anomalies may lead to more believable and trustworthy explanations.

By minimizing anomalies, generative machine learning model 132 may increase the trustworthiness and credibility of the counterfactual explanations. Enhanced credibility may be crucial for building trust in AI systems and making informed decisions based on their outputs. The approximated data-likelihood gradient may allow for efficient exploration of the latent space, focusing the search on areas with higher data-likelihood. More efficient exploration may lead to faster and more effective generation of high-quality counterfactuals.

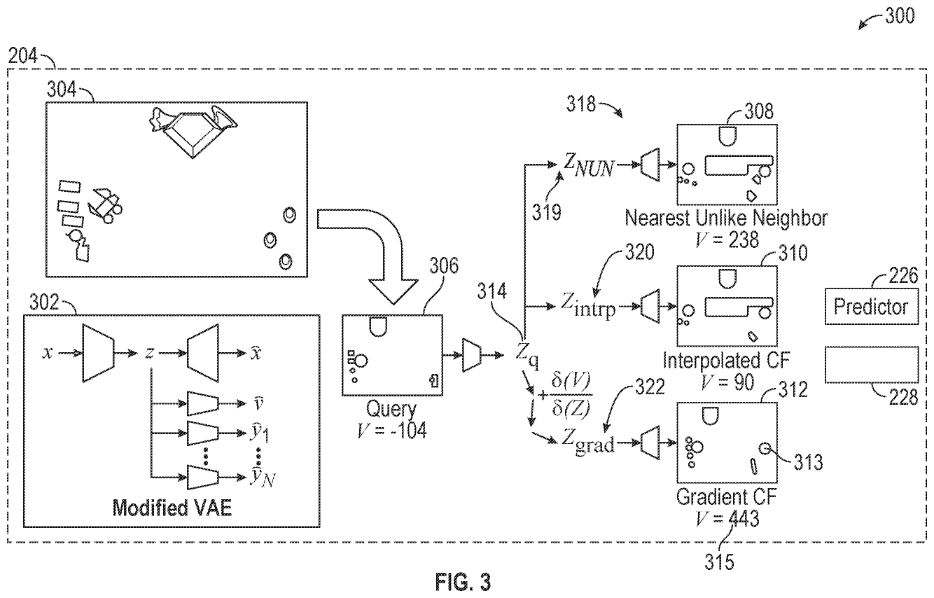

In an aspect, generative machine learning model 132 may be implemented, for example, using VAE 302 shown in FIG. 3. VAE 302 may compress high-dimensional data (x) into a lower-dimensional latent space (z). The encoder (enc) may map the input to its latent representation (z=enc(x)). The decoder (dec) may reconstruct the input from the latent representation (x≈dec(z)). The latent representation may be regularized by minimizing the KL divergence between a prior distribution (q(z), typically a standard Gaussian) and the conditional distribution induced by the encoder (q(z|x)). Regularization may ensure the latent space is smooth and avoids overfitting to specific data points.

The VAE loss function may consist of two terms: reconstruction loss and KL divergence. Reconstruction loss may measure how well the decoder reconstructs the original input.

KL divergence may penalize the deviation of the latent distribution from the prior distribution. The VAE loss may be a lower bound on the data likelihood. In other words, minimizing the VAE loss may encourage the model to generate data that is similar to the training data 213. New data points may be generated by sampling from the prior distribution and passing the samples through the decoder. VAE 302 is a generative model that may learn the underlying structure of data. VAE 302 may use a latent space to represent the data in a compressed and informative way. By minimizing the loss, VAE 302 may learn to reconstruct the training data 213 and generate new data points that are similar to the training data 213.

For illustrative purposes only, let M represent the model whose behavior is explored. X_Q may be a query input and x_c may be a generated counterfactual input. The counterfactual input, x_c, should be “related” to the query input, x_Q. In other words, there should be some level of similarity or connection between the two inputs. However, x_c should also lead to a different behavior from the model compared to x_Q. The behavior of model M may be quantified using a vector of outcome variables y=(y_1, . . . , y_A).

Each outcome variable may measure a different aspect of the model's behavior. For example, if M is a reinforcement learning agent, the outcome variables might include: value achieved by the agent, secondary performance measures like time to reach the goal, and categorical measures like whether the agent violated constraints.

By generating counterfactual inputs x_c with different properties and observing their corresponding outcome variables y_c, valuable insights may be gained into the model's behavior. Such generation of counterfactuals may provide understanding how the M model may respond to changes in the input and which factors may contribute to different outcomes. Counterfactual analysis may help to understand how models behave by exploring alternative scenarios. By analyzing the outcomes of counterfactual inputs compared to the actual input, analysts may gain insights into the model's decision-making process and may help to identify potential biases or limitations. As a result, the information provided by the disclosed techniques may be used to improve the model's performance, develop better training strategies, and build more robust and reliable models.

In an aspect, generative machine learning model 132 may generate counterfactuals by perturbing the latent representation of the query input. In an aspect, generative machine learning model 132 implemented as VAE 302 may learn a latent representation of the data. The latent representation may capture the underlying structure of the data in a lower-dimensional space.

In an aspect, machine learning system 204 may further include counterfactual evaluation module 228. In an aspect, counterfactual evaluation module 228 may be configured to employ at least three key measures used to evaluate counterfactual generation methods: proximity, plausibility, and validity, as discussed below in conjunction with FIG. 3. The above techniques are described with respect to a single machine learning system 204 implemented by computing system 200. However, aspects of machine learning system 204 may be distributed among multiple systems. For example, a first training data generation system may generate the training counterfactuals as described herein. A second machine learning system 204 may process the training data 213 to train generative machine learning model 132. Finally, a third system may apply the trained generative machine learning model 132 to process queries received from a user and generate one or more counterfactuals corresponding to the received query.

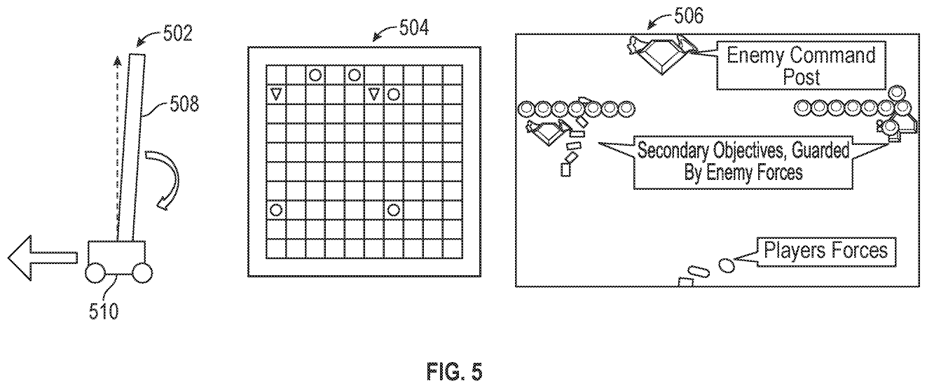

FIG. 3 is a conceptual diagram illustrating an example of a counterfactual generation architecture according to techniques of this disclosure. More specifically, FIG. 3 illustrates a method for generating counterfactual examples in an example domain using VAE 302 trained to both reconstruct the input and predict several outcome variables, including, but not limited to, the agent's value function. VAE 302 may be trained to learn a latent representation of the data (z_{q}) 314 that allows for reconstruction of the original input and prediction of outcome variables. Query instance 306 is a specific example in the StarCraft II game domain 304 that may be encoded as spatial feature layers. StarCraft II game domain 304 is described below in conjunction with FIG. 5. Query 306 illustrates a low-value query instance with agent units, enemy units, and capturable assets.

The disclosed framework/architecture 300 has a goal of generating a higher-value counterfactual examples, essentially one or more scenarios that would have resulted in a more favorable outcome for the agent. FIG. 3 also illustrates three different methods for generating counterfactuals: Nearest Unlike Neighbor (NUN) 318, partial latent interpolation 320 and gradient-based method 322.

In an aspect, NUN method 318 may find the most similar data point to the query instance 306 that has a higher value. This similar instance may then be used as the counterfactual 308.

In an aspect, the partial latent interpolation method 320 may interpolate between the query instance's latent representation (z_{q}) 314 and the NUN's latent representation (z_nun) 319 to create a new latent representation. The new latent representation may then be decoded to obtain the counterfactual example 310.

The gradient-based method 322 may use the gradient of the value function with respect to the latent variables to find a direction in the latent space that may lead to a higher value. The query instance's latent representation may then be moved in this direction to create the counterfactual 312.

For example, adding an additional target depicted as circle 313 for the agent shown in FIG. 3 may increase the estimated value 315. The interpolation 320 and gradient-based 322 methods may produce counterfactuals 310 and 312, respectively, with fewer defending forces and placement of obstacles compared to the NUN method 318. In the context of example illustrated in FIG. 3, spatial feature layers may represent the game state as a collection of maps, where each map encodes specific information about the game world (e.g., unit positions, resources, and the like).

To generate a counterfactual, VAE 302 may perturb the latent representation of the input query 306. Such perturbation may be implemented in various ways, such as, but not limited to adding noise or applying specific transformations to the latent space.

The perturbed latent representation may then be decoded by VAE 302 to obtain the counterfactual input. In this case, VAE may be extended to reconstruct not only the input but also the outcome variables from the latent representation 314.

The disclosed techniques enable VAE 302 to achieve reconstruction of outcome variables using separate predictors for each outcome variable, allowing VAE 302 to learn the relationship between the input and the outcomes in the latent space. The disclosed techniques exploit the ability of VAEs 302 to learn latent representations with meaningful axes of variation. In other words, different axes in the latent space may correspond to different aspects of the data. By traversing the latent space, VAE 302 may explore various variations of the input while ensuring they remain “related” to the query input 306.

In an aspect, the joint reconstruction of input and outcomes in the latent space may ensure that the encoded information captures the relationship between the two. For example, outcome-aware latent encoding may allow for more targeted perturbations that specifically aim to achieve a desired outcome change. The disclosed techniques may leverage the strengths of VAEs 302, such as their ability to learn meaningful latent representations and generate diverse samples. VAE 302 may facilitate the generation of counterfactuals 308, 310, and 312 that are related to the query input 306 but lead to different outcomes. By jointly encoding input (e.g., RL agent's observations) and outcomes, VAE 302 may ensure that generated counterfactuals 308, 310, and 312 are consistent with the observed data and reflect the underlying relationships between the variables.

In addition, machine learning system 204 may include a predictor 226 that may be trained to determine if a generated counterfactual candidate meets the desired outcome criteria. When generating counterfactuals 308, 310, and 312, machine learning system 204 may include specific criteria in for what constitutes a successful/valid counterfactual. Such criteria may involve, for example, achieving a desired change in the outcome variable compared to the original input. In an aspect, predictor 226 may be trained alongside the VAE 302.

Predictor 226 may take the counterfactual input as input and may predict its outcome variable. By comparing the predicted outcome to the desired outcome criteria, machine learning system 204 may determine if the counterfactual is successful/valid.

Furthermore, trained predictor 226 may help machine learning system 204 to avoid the need to repeatedly run the full model to evaluate the outcome of each generated counterfactual. Predictor 226 may be trained on specific outcome criteria, allowing for customization to different analysis goals. Predictor 226 may provide insights into the factors that contribute to the outcome variable, such as outcome variable 315, for example.

Trained predictor 226 may be used as a proxy to estimate the outcome of counterfactuals 308, 310, and 312. A counterfactual may be considered valid if it achieves the desired change in the outcome variable(s) compared to the original input. To determine validity, machine learning system 204 may use a validity predicate, denoted as K_{i, s, f}. The validity predicate may take three arguments: I (index of outcome variable), s (original state or input) and f (counterfactual state or input). The desired change may be specified by desired_sign and desired_size (desired magnitude of change).

Although the aforementioned example focuses on a single outcome variable (i), the described technique may be easily extended to handle multiple criteria simultaneously. Multiple variable evaluation may require defining separate validity predicates for each outcome variable and evaluating them independently.

As discussed above, FIG. 3 illustrates three different methods 318, 320, and 322 of counterfactual generation. NUN 318 refers to a data point drawn from a library of observed instances that shares certain similarities to the query input but has an outcome that fulfills the desired counterfactual criterion. NUN 318 may serve as a baseline for comparison in counterfactual analysis and may provide a reliable way to obtain valid and plausible counterfactual explanations.

To find the NUN, machine learning system 204 may minimize the “observational distance” between the query input and the potential NUNs. Such minimization may ensure the NUN remains sufficiently similar to the query input 306 in terms of its observed features. Simultaneously, the NUN should also satisfy the pre-defined counterfactual criterion, which typically involves achieving a specific outcome change. The specific method for minimizing the observational distance may depend on the data type and chosen distance metric.

Common distance metrics may include, but are not limited to, Euclidean distance for numerical data and cosine similarity for categorical data. The chosen metric should effectively capture the similarities and differences between instances in the data space.

The counterfactual criterion may be defined in various ways, depending on the specific analysis goal. The counterfactual criterion may involve, for example, achieving a desired change in a specific outcome variable, violating certain constraints, or exhibiting specific behaviors. The NUN selection process may ensure that the chosen counterfactual satisfies the pre-defined criterion. NUN method 318 may provide a readily available and computationally efficient way to generate counterfactuals. By leveraging existing data points, NUN may guarantee the plausibility and validity of the generated counterfactual explanations. NUN method 318 may also serve as a valuable benchmark for comparing the performance of other counterfactual generation methods. The quality of NUNs may depend heavily on the diversity and representativeness of the available data. In cases where relevant data points are scarce or the counterfactual criterion is particularly complex, finding a suitable NUN might be difficult. NUN-based counterfactuals 308 may not always be as diverse or informative as those generated by more advanced methods.

While NUN method 318 ensures plausibility by utilizing existing data points, these may not be sufficiently “proximal” to the query input 306, potentially limiting the insights gained. To address this, machine learning system 204 may employ interpolation between the query 306 and the NUN in the latent space, aiming to find counterfactuals closer to the query 306 while still satisfying the counterfactual criterion. Machine learning system 204 may use its knowledge of the latent representation to generate a counterfactual related to the query input 306. Latent space interpolation method 320 may leverage the generative model's ability to navigate the latent space. Machine learning system 204, which may be implemented as VAE 302 in the example shown in FIG. 3, may linearly interpolate between the latent encodings of the query (zq) 314 and the NUN (zj) to obtain a new latent representation (z′). The scaling factor alpha (a) may be sampled between 0 and 1. Machine learning system 204 may continue the interpolation process until a point is found where the counterfactual criterion is first met. Interpolation termination may ensure the generated counterfactual 310 satisfies the desired outcome change. If alpha reaches 1 without finding such a point, the interpolation may be considered unsuccessful, and the NUN itself may be returned.

To further enhance the plausibility of the generated counterfactual, machine learning system 204 may apply a “plausibility adjustment.” Plausibility adjustment may involve updating the interpolated latent representation (z′) based on the gradient of the anomaly score.

The machine learning system 204 may determine the magnitude of the adjustment (A) through a grid search along the direction of the gradient, focusing on the point with the lowest anomaly score. The plausibility adjustment may help to steer the generated counterfactual closer to regions in the latent space with higher data-likelihood, making it more realistic and consistent with the observed data. The plausibility adjustment may reduce the risk of generating anomalous or implausible counterfactuals. By combining NUN with interpolation and plausibility adjustment, machine learning system 204 may leverage the strengths of each method. NUN may ensure the validity and plausibility of the counterfactual by utilizing existing data points. Latent space interpolation may allow for exploration of counterfactuals closer to the query input. Plausibility adjustment may further improve the quality of the generated counterfactual by focusing on realistic and data-consistent scenarios.

Instead of interpolating towards a specific data point like NUN, iterative gradient updates method 322 may directly utilize the gradient signal to shift the latent representation towards the desired outcome. This method may avoid the need for finding a suitable NUN and may allow for more flexible exploration of the latent space.

For example, the latent representation (z) 314 may be updated iteratively using the gradient of the desired outcome predictor. The sign of the desired change may be controlled by the parameter desired_sign (−1 or 1). The update step size may be determined by the scaling terms λ₁ and λ₂. After each gradient update, machine learning system 204 may apply a plausibility adjustment to shift the latent representation towards a higher data-likelihood state. Machine learning system 204 may apply the plausibility adjustment by adding a term proportional to the gradient of the data-likelihood. By applying plausibility adjustment, machine learning system 204 may ensure the generated counterfactual 312 remains consistent with the observed data and avoids unrealistic scenarios.

Machine learning system 204 may continue the update process until the counterfactual criterion is satisfied or a maximum number of steps is reached. Such counterfactual criterion and termination may ensure the generated counterfactual fulfills the desired outcome change. It should be noted that the gradient update over a latent space trained only for reconstruction, without the plausibility adjustment, may be equivalent to XGEMS and similar known methods. XGEMS may primarily focus on reconstruction accuracy and may not guarantee the plausibility of generated counterfactuals. Gradient based method 322 may allow for more flexible exploration of the latent space compared to interpolation-based method 320. Gradient based method 322 may be more computationally efficient than searching for a suitable NUN. The plausibility adjustment may help to ensure the generated counterfactuals are realistic and consistent with the observed data. Both NUN interpolation 320 and gradient-based methods 322 may have their strengths and weaknesses. NUN interpolation 320 may guarantee plausibility but may be less flexible. Gradient-based method 322 may be more flexible but may require careful design of the update steps and plausibility adjustments to ensure validity and plausibility.

As noted in conjunction with FIG. 2, machine learning system 204 may further include counterfactual evaluation module 228. In an aspect, counterfactual evaluation module 228 may be configured to employ at least three key measures used to evaluate counterfactual generation methods: proximity, plausibility and validity.

Counterfactual evaluation module 228 may use proximity measure to assess how different a generated counterfactual is from its original query. In other words, the proximity measure may quantify the similarity between the two instances. A lower proximity score may indicate that the counterfactual is more dissimilar from the query, which could be desirable if the goal is to find significantly different scenarios that still satisfy the counterfactual criterion. However, a very low proximity might also make the counterfactual less interpretable or less relevant to the original scenario. Maintaining high proximity may be crucial because high proximity may allow for better understanding of the relationships between features and outcome variables. Sparser differences between the counterfactuals 308, 310, and 312 and the original query 306, measured by feature-level edit distance metrics, may indicate better proximity because fewer changes are more likely to reveal the true causal effects of specific features on the outcome. Counterfactual evaluation module 228 may use plausibility measure to evaluate whether the generated counterfactual is something that would be considered realistic or believable within the context of the domain. Plausibility may be important because counterfactuals that are too outlandish or improbable may not be useful for understanding the underlying causal relationships. A high plausibility score may suggest that the counterfactual is consistent with the expectations of someone familiar with the domain. High plausibility is important to ensure user trust in the counterfactuals. Users are more likely to engage with counterfactuals that they perceive as being realistic and consistent with their existing knowledge of the domain. Plausibility may be measured by the likelihood of the counterfactual occurring in the real world, based on the actual data available. Counterfactual evaluation module 228 may use validity measure to assesses whether the generated counterfactual satisfies a specific counterfactual criterion, denoted by K. The nature of this criterion may vary depending on the specific application and the desired properties of the counterfactual. For example, the criterion might specify that the counterfactual should change a specific feature of the query while keeping everything else constant, or the criterion may require that the counterfactual should produce a specific outcome. A high validity score may indicate that the counterfactual meets the desired criteria. This property ensures that the generated counterfactuals 308, 310, and 312 actually meet the intended counterfactual criterion (denoted by K). This criterion may vary depending on the specific application, but it typically involves specifying the desired changes to be made to the original instance and verifying that the resulting counterfactual satisfies those changes. Without validity, the counterfactuals 308, 310, and 312 may become meaningless and may not be used to draw accurate inferences about the causal relationships at hand.

In an aspect, counterfactual evaluation module 228 may calculate an observational difference score, which may measure the inverse of proximity between two instances. The observational difference score may be used to evaluate how close a generated counterfactual is to its original query. In an aspect, counterfactual evaluation module may define a function called observational_difference_score. The observational_difference_score function may take two instances as input and may return their observational difference score. In an aspect, counterfactual evaluation module 228 may iterate over all features in the first instance: for each feature, counterfactual evaluation module 228 may check if the corresponding value is present in the second instance.

In one example, counterfactual evaluation module 228 may calculate the difference based on feature type. For categorical features, counterfactual evaluation module 228 may use a feature edit distance, which simply may be the number of label changes required to convert one value to the other. For numeric features, counterfactual evaluation module 228 may calculate the absolute difference between the two values and then may normalize to a range of 0-1 using a provided interval width. If a feature is missing in either instance, such feature may be automatically considered different and may contribute a score of 1. Counterfactual evaluation module 228 may obtain the final score by summing the differences across all features. In summary, the observational difference score may provide a quantitative measure of how different two instances are. The observational difference score may be particularly useful for evaluating the proximity of counterfactuals to their original queries.

It should be noted that the interval width used by counterfactual evaluation module 228 for normalizing numeric features may be adjusted based on the specific application. The observational difference score may be just one non-limiting way to measure the proximity of counterfactuals. Other methods may be more suitable and may be utilized by counterfactual evaluation module 228 depending on the specific context.

Since no method guarantees valid counterfactuals every time, an evaluation by counterfactual evaluation module 228 may be necessary to measure performance of the counterfactuals 308, 310, and 312. Even with advanced methods described above, there may be no absolute certainty that generated counterfactuals will adhere to the desired criteria.

To assess the effectiveness of different counterfactual generation methods, counterfactual evaluation module 228 may evaluate various method's ability to produce valid counterfactuals. Valid counterfactual rate, which may be denoted as rH, for example, may represent the fraction of queries for which a method successfully generated a valid counterfactual. Valid counterfactual rate may essentially measure the success rate of the method in achieving intended purpose of that method. In an aspect, counterfactual evaluation module 228 may assess the performance based on a set of N queries, providing a more robust and reliable evaluation compared to single instances. It should be noted that the specific definition of “valid” may depend on the intended application and the chosen counterfactual criterion (K).

While rH measure may provide a general measure of success, it may be important for counterfactual evaluation module 228 to analyze other factors like proximity and plausibility for a complete understanding of the method's effectiveness. Counterfactual evaluation module 228 may rely on the observation that autoencoders tend to “denoise” anomalous inputs. In other words, autoencoders typically try to reconstruct a more typical or expected version of the data during the decoding process. As shown in FIG. 3, the original instance may be first encoded into a latent representation using the autoencoder's encoder function (enc).

In an aspect, autoencoder, such as VAE 302, may then decode the encoded representation (z) back into the data space using the autoencoder's decoder function (dec). Autoencoder may also perform a reconstruction of the original instance (e.g., query 306) directly from the encoder's output. In an aspect, counterfactual evaluation module 228 may calculate the difference between the decoded representation and the reconstructed instance using, for example, the odiff function. The calculated difference may capture how much the autoencoder has altered the original data during the encoding and decoding process. Counterfactual evaluation module 228 may interpret the observational difference as an anomaly score (anom(z)). A higher score may indicate that the latent representation is considered more “anomalous” or unlikely to be observed in the real data. Essentially, counterfactual evaluation module 228 may assume that if the autoencoder significantly modifies the data during reconstruction, then the original instance and the corresponding latent representation are likely to be anomalous. Conversely, a low anomaly score may suggest that the latent representation is considered more plausible and representative of the typical data distribution.

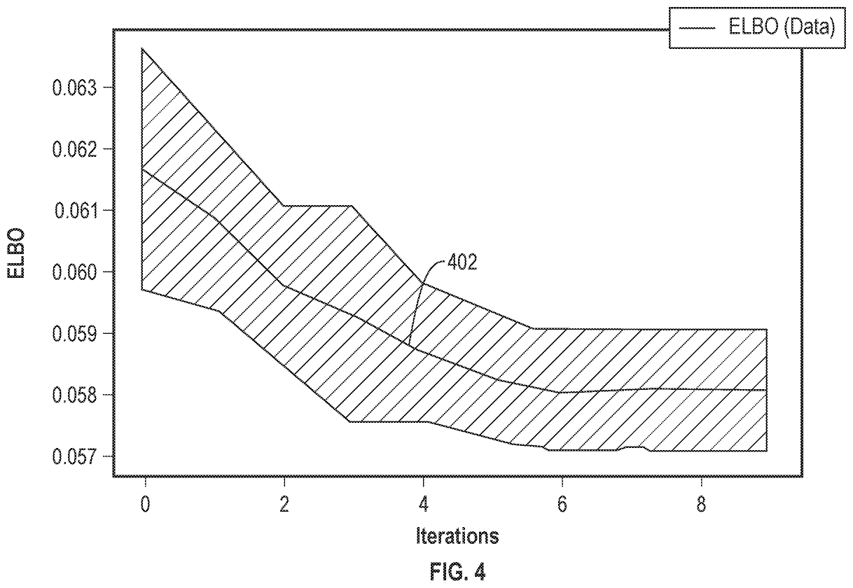

FIG. 4 is a graph 402 illustrating an example Evidence Lower Bound (ELBO) loss against number of the round trips for the input according to techniques of this disclosure. FIG. 4 shows the mean and standard deviation of the ELBO loss for the input at each step of the encoding-decoding recurrence based on 1000 scenes sampled from a StarCraft II minigame dataset, described below in conjunction with FIG. 5. ELBO may serve as a proxy for the likelihood of the data. Lower ELBO may indicate higher likelihood. As shown in FIG. 4, ELBO decreases with each iteration, indicating that the reconstructions may become more likely as the process iterates. This decrease is most significant in the first step, suggesting that the initial encoding-decoding step has the greatest impact on plausibility. Similar results may be observed when repeating the process with randomly sampled latent variables. Deep generative models like VAEs might not be well-calibrated for outlier detection. The disclosed techniques do not aim to estimate a precise distribution, but rather to increase the likelihood (and therefore plausibility) of the reconstructions.

FIG. 5 is a conceptual diagram illustrating example environments that could be used in counterfactual generation according to techniques of this disclosure. More specifically, FIG. 5 illustrates 3 different reinforcement learning environments: Cartpole environment 502, Canniballs environment 504, and a custom minigame in the StarCraft II learning environment 506

Cartpole environment 502 is a popular benchmark for reinforcement learning algorithms. Cartpole is a two-dimensional physics simulation that involves balancing a pole 508 on a moving cart 510. The agent controls the cart 510 by moving it left and right. The goal is to keep the pole 508 upright and balanced for as long as possible. The agent receives a reward for each timestep that the pole 508 remains upright. The episode ends under two conditions: the pole 508 falls over beyond a certain angle and/or the cart 510 moves too far from its original position. The agent observes the environment 502 through four continuous parameters: cart velocity (the speed of the cart 510), cart position (the horizontal position of the cart 510), pole angle (the angle of the pole 508 relative to the vertical) and pole angular velocity (the rate at which the pole 508 is rotating). The Cartpole environment 502 provides a challenging task for reinforcement learning algorithms. The continuous state space and complex dynamics require the agent to learn efficient policies for balancing the pole 508. The environment is widely used as a benchmark for testing and comparing different reinforcement learning algorithms.

Cannibals 504 is a gridworld game where the player controls a red ball and interacts with other entities in the environment. The player earns rewards for consuming weaker entities and avoids being consumed or stalling. Episodes have a fixed length and end when the player is consumed or the maximum number of steps is reached. All entities, including the player, have a strength level. The player can only consume entities weaker than itself. Strength increases by consuming different types of entities: colored balls exhibit various behaviors like random movement, bouncing, or chasing the player. Triangles offer another source of strength gain. The game environment 504 is stochastic. In other words, in the game environment 504 the behavior of other entities and rewards are not fully predictable. The player receives information about the environment 504 through a set of categorical spatial feature layers. These layers provide information about the presence and type of entities in different locations on the grid. The Cannibals environment 504 presents several challenges for reinforcement learning algorithms due to: multiple subgoals, high stochasity, partial information. Multiple subgoals include balancing the need to consume weaker entities while avoiding being consumed and staying within the episode time limit. High stochasticity includes unpredictable behavior of other entities and rewards. Partial information includes limited observation space through categorical layers. The Cannibals environment 504 serves as a benchmark for testing and developing reinforcement learning algorithms that can handle complex and unpredictable scenarios. The Canniballs environment 504 allows to study how agents learn to navigate environments with multiple objectives and incomplete information.

StarCraft is a multiplayer real-time strategy game with diverse unit types and buildings. Each unit has unique strengths and weaknesses, requiring strategic decision-making for optimal deployment. Buildings offer various functionalities and can be destroyed or captured. The StarCraft environment 506 is specifically designed to test complex decision-making skills in agents. The player controls one of the teams and receives rewards for: destroying enemy units, capturing secondary objectives (providing reinforcements), destroying the enemy's command center (victory condition). Captured secondary objectives grant reinforcements, allowing the player to overcome obstacles. The player receives information through a complex spatial observation space with multiple layers. These layers contain both numerical and categorical data, providing rich but intricate information about the game state. The observation space in StarCraft environment 506 is significantly more detailed and intricate compared to the Cartpole 502 and Cannibals 504 environments. StarCraft environment 506 presents significant challenges for reinforcement learning due to: real-time nature (requires fast decision-making under pressure), incomplete information (gull game state is not available to the agent), high complexity (diverse units, buildings, and objectives require sophisticated strategies), partial observability and adversarial nature (requires anticipating and adapting to opponent's actions).

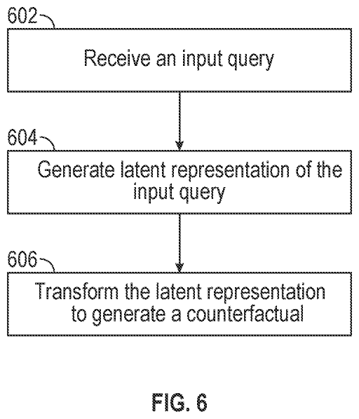

FIG. 6 is a flowchart illustrating an example mode of operation for a machine learning system, according to techniques described in this disclosure. Although described with respect to computing system 200 of FIG. 2 having processing circuitry 243 that executes machine learning system 204, mode of operation 600 may be performed by a computation system with respect to other examples of machine learning systems described herein.

In mode operation 600, processing circuitry 243 executes machine learning system 204. Machine learning system 204 may receive, by a trained generative machine learning model 132, an input query 306 (602). Generative machine learning model 132 may be trained by jointly encoding a plurality of Reinforcement Learning (RL) agent's observations and a plurality of outcome variables corresponding to the plurality of RL agent's observations. Generative machine learning model 132 may next generate latent representation of the input query (604). In an aspect, the latent representation may capture the underlying structure of the data in the input query 306 in a lower-dimensional space. Next, generative machine learning model 132 may transform the latent representation of the input query to generate a counterfactual related to the received input query (606). In an aspect, the generated counterfactual may meet a predefined outcome criteria.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for generating counterfactuals, the method comprising:
receiving, by a trained generative machine learning model, an input query, wherein the generative machine learning model is trained by jointly encoding a plurality of input observations and a plurality of outcome variables based on the plurality of input observations;
generating, by the trained generative machine learning model, a latent representation of the input query; and
transforming, by the trained generative machine learning model, the latent representation of the input query to generate a counterfactual related to the received input query, wherein the generated counterfactual meets a predefined outcome criteria.

2. The method of claim 1, wherein the trained generative machine learning model comprises an autoencoder.

3. The method of claim 1, further comprising:
applying a plausibility adjustment to the generated counterfactual to generate an adjusted, generated counterfactual.

4. The method of claim 1, wherein transforming the latent representation of the input query further comprises transforming the latent representation using a Nearest Unlike Neighbor (NUN) technique.

5. The method of claim 1, wherein transforming the latent representation of the input query further comprises transforming the latent representation using a latent interpolation technique.

6. The method of claim 1, wherein transforming the latent representation of the input query further comprises transforming the latent representation using a gradient-based technique.

7. The method of claim 1, wherein transforming the latent representation of the input query further comprises determining, using a trained predictor, if a generated candidate for a counterfactual meets the predefined outcome criteria to determine if the generated candidate comprises a valid counterfactual.

8. The method of claim 1, further comprising:
evaluating the generated counterfactual using one or more counterfactual evaluation measures.

9. The method of claim 8, wherein the one or more counterfactual evaluation measures include at least one of: proximity, plausibility and validity.

10. The method of claim 1, wherein the plurality of input observations comprises a plurality of Reinforcement Learning (RL) agent's observations.

11. A computing system for generating counterfactuals comprising:
processing circuitry in communication with storage media, the processing circuitry configured to execute a machine learning system configured to:
receive, by a trained generative machine learning model, an input query, wherein the generative machine learning model is trained by jointly encoding a plurality of input observations and a plurality of outcome variables based on the plurality of input observations;
generate, by the trained generative machine learning model, a latent representation of the input query; and
transform, by the trained generative machine learning model, the latent representation of the input query to generate a counterfactual related to the received input query, wherein the generated counterfactual meets a predefined outcome criteria.

12. The system of claim 11, wherein the trained generative machine learning model comprises an autoencoder.

13. The system of claim 11, wherein the machine learning system is further configured to:
apply a plausibility adjustment to the generated counterfactual to generate an adjusted, generated counterfactual.

14. The system of claim 11, wherein the machine learning system configured to transform the latent representation of the input query is further configured to transform the latent representation using a Nearest Unlike Neighbor (NUN) technique.

15. The system of claim 11, wherein the machine learning system configured to transform the latent representation of the input query is further configured to transform the latent representation using a latent interpolation technique.

16. The system of claim 11, wherein the machine learning system configured to transform the latent representation of the input query is further configured to transform the latent representation using a gradient-based technique.

17. The system of claim 11, the machine learning system configured to transform the latent representation of the input query is further configured to determine, using a trained predictor, if a generated candidate for a counterfactual meets the predefined outcome criteria to determine if the generated candidate comprises a valid counterfactual.

18. The system of claim 11, wherein the machine learning system is further configured to:
evaluate the generated counterfactual using one or more counterfactual evaluation measures.

19. The system of claim 18, wherein the one or more counterfactual evaluation measures include at least one of: proximity, plausibility and validity.

20. Non-transitory computer-readable storage media having instructions for generating counterfactuals encoded thereon, the instructions configured to cause processing circuitry to receive, by a trained generative machine learning model, an input query, wherein the generative machine learning model is trained by jointly encoding a plurality of input observations and a plurality of outcome variables based on the plurality of input observations;
generate, by the trained generative machine learning model, a latent representation of the input query; and
transform, by the trained generative machine learning model, the latent representation of the input query to generate a counterfactual related to the received input query, wherein the generated counterfactual meets a predefined outcome criteria.
